(19) United States
(12) Patent Application Publication
(10) Pub. No.: US 2026/0253895 A1
(43) Pub. Date: Aug. 27, 2026

(54) ANODE ACTIVE MATERIAL FOR SECONDARY BATTERY, METHOD OF PREPARING THE SAME AND SECONDARY BATTERY INCLUDING THE SAME

(71) Applicant: SK ON CO., LTD., Seoul (KR)

(72) Inventors: Mi Ryeong LEE, Daejeon (KR); Jong Hyuk LEE, Daejeon (KR); Hae Suk HWANG, Daejeon (KR)

(21) Appl. No.: 19/545,026

(22) Filed: Feb. 20, 2026

(30) Foreign Application Priority Data
Feb. 24, 2025 (KR) 10-2025-0023933

(51) Int. Cl. H01M 4/587; C01B 32/21; H01M 4/02; H01M 4/36; H01M 10/052

(52) U.S. Cl. CPC H01M 4/587; C01B 32/21; H01M 4/366; H01M 10/052; C01P 2004/03; C01P 2004/32; C01P 2004/61; C01P 2004/80; C01P 2006/12; C01P 2006/40; H01M 2004/027

(57) ABSTRACT

An anode active material for a secondary battery includes natural graphite particles. A first sphericity distribution defined by Sp90−Sp10 of the natural graphite particles is 0.25 or less, and a second sphericity distribution defined by Sp90−Sp50 of the natural graphite particles is 0.15 or less. Sp10, Sp50 and Sp90 represent sphericities at volume fractions of 10%, 50% and 90%, respectively, in a volume-weighted particle size distribution of the natural graphite particles accumulated from the smallest particle size.

### CROSS-REFERENCE TO RELATED APPLICATION

This application claims priority to Korean Patent Application No. 10-2025-0023933 filed on Feb. 24, 2025, the entire disclosure of which is incorporated by reference herein.

### BACKGROUND

### 1. Field

The present disclosure relates to an anode active material for a secondary battery, a method of preparing the same and a secondary battery including the same.

### 2. Descriptions of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle such as an hybrid automobile.

Examples of the secondary battery include a lithium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

For example, a lithium secondary battery may include a cathode and an anode. An electrode such as the cathode and the anode may include an electrode active material capable of reversibly absorbing and releasing lithium ions. A current may be generated through a chemical reaction in the electrode. A graphite-based material or a silicon-based material may be used as an active material for the anode.

### SUMMARY

According to an aspect of the present disclosure, there is provided an anode active material for a secondary battery having improved electrical properties and life-span properties.

According to an aspect of the present disclosure, there is provided a method of preparing an anode active material for a secondary battery having improved electrical properties and life-span properties.

According to an aspect of the present disclosure, there is provided a secondary battery including the anode active material for a secondary battery.

An anode active material for a secondary battery includes natural graphite particles. A first sphericity distribution defined by Equation 1 of the natural graphite particles is 0.25 or less, and a second sphericity distribution defined by Equation 2 of the natural graphite particles is 0.15 or less.

$$first sphericity distribution = Sp 90 - Sp 10 \qquad [ Equation 1 ]$$

$$second sphericity distribution = Sp 90 - Sp 50 \qquad [ Equation 2 ]$$

In Equations 1 and 2, Sp10, Sp50 and Sp90 represent sphericities at volume fractions of 10%, 50% and 90%, respectively, in a volume-weighted particle size distribution of the natural graphite particles accumulated from the smallest particle size.

In some embodiments, the first sphericity distribution of the natural graphite particles may be in a range from 0.1 to 0.2.

In some embodiments, the second sphericity distribution of the natural graphite particles may be in a range from 0.03 to 0.10.

In some embodiments, Sp10 of the natural graphite particles may be in a range from 0.65 to 0.8.

In some embodiments, Sp50 of the natural graphite particles may be in a range from 0.75 to 0.9.

In some embodiments, Sp90 of the natural graphite particles may be in a range from 0.85 to 1.

In some embodiments, an average particle diameter (D50) of the natural graphite particles may be in a range from 5 μm to 20 μm.

In some embodiments, a specific surface area of the natural graphite particles may be 8 m²/g or less.

In some embodiments, a carbon coating layer may be further formed on a surface of the natural graphite particles. A content of the carbon coating layer may be in a range from 1 wt % to 15 wt % based on a total weight of the anode active material.

An anode for a secondary battery includes an anode current collector, and an anode active material layer formed on the anode current collector and including the above-described anode active material for a secondary battery.

In some embodiments, an orientation degree of the anode active material layer defined by Equation 3 may be 30 or less.

$$orientation degree = I ( 0 \; 04 ) / I ( 110 ) \qquad [ Equation 3 ]$$

In Equation 3, I(004) is a peak intensity of a (004) plane of the anode active material layer measured by an X-ray diffraction (XRD) analysis, and I(110) is a peak intensity of a (110) plane of the anode active material layer measured by the XRD analysis.

A secondary battery includes the above-described anode for a secondary battery, and a cathode opposing the anode.

In a method for preparing an anode active material for a secondary battery, a flake graphite material having an average particle diameter (D50) of 50 μm to 180 μm is introduced into a reactor. The flake graphite material is stirred for 0.5 to 10 hours to prepare natural graphite particles. A first sphericity distribution defined by Equation 1 of the natural graphite particles is 0.25 or less, and a second sphericity distribution defined by Equation 2 of the natural graphite particles is 0.15 or less.

$$first sphericity distribution = Sp 90 - Sp 10 \qquad [ Equation 1 ]$$

$$second sphericity distribution = Sp 90 - Sp 50 \qquad [ Equation 2 ]$$

In Equations 1 and 2, Sp10, Sp50 and Sp90 represent sphericities at volume fractions of 10%, 50% and 90%, respectively, in a volume-weighted particle size distribution of the natural graphite particles accumulated from the smallest particle size.

In some embodiments, an average particle diameter (D50) of the flake graphite material may be 80 μm to 150 μm.

In some embodiments, a stirring rate of the flake graphite material in the stirring may be in a range from 500 rpm to 20,000 rpm.

In some embodiments, an acidic compound may be added to the reactor to acid-treat the natural graphite particles after the stirring.

In some embodiments, after the acid-treatment, a carbon material may be added to the reactor. A heat treatment may be performed to form a carbon coating layer on the surface of the natural graphite particles.

According to embodiments of the present disclosure, an anode active material for a secondary battery may include natural graphite particles having a uniform sphericity distribution. Accordingly, the anode active material may provide improved power and capacity properties while reducing a diffusion path of lithium ions, so that charge/discharge properties may be enhanced.

In a method for preparing an anode active material for a secondary battery according to embodiments of the present disclosure, the natural graphite particles may be prepared from a flake graphite material. In example embodiments, an average particle diameter (D50) of the flake graphite material may be controlled to facilitate a spheroidization.

The anode active material and the lithium secondary battery according to the present disclosure may be widely applied in green technology fields such as an electric vehicle, a battery charging station, a solar power generation, a wind power generation, etc., using a battery, etc. The anode active material and the lithium secondary battery according to the present disclosure may be used for eco-friendly electric vehicles and hybrid vehicles to prevent a climate change by suppressing air pollution and greenhouse gas emissions, etc.

### BRIEF DESCRIPTION OF THE DRAWINGS

FIG. 1 and FIG. 2 are a schematic plan view and a schematic cross-sectional view, respectively, illustrating a lithium secondary battery in accordance with example embodiments.

FIGS. 3 to 5 are SEM images of cross-sections of anode active materials of Example 1, Example 2 and Comparative Example 1, respectively.

### DETAILED DESCRIPTION OF THE EMBODIMENTS

According to embodiments of the present disclosure, an anode active material for a lithium secondary battery (hereinafter, that may be abbreviated as an anode active material) including natural graphite particles.

According to embodiments of the present disclosure, a method for preparing the anode active material for a secondary battery is provided.

According to embodiments of the present disclosure, a secondary battery including the anode active material for a secondary battery is provided.

Hereinafter, the present disclosure will be described in detail with reference to the attached drawings and example embodiments. However, those are merely provided as examples and the present disclosure is not limited to the specific embodiments disclosed herein.

According to embodiments, the anode active material includes natural graphite particles having a first sphericity distribution defined by Equation 1 of 0.25 or less, and a second sphericity distribution defined by Equation 2 of 0.15 or less.

$$first sphericity distribution = Sp 90 - Sp 10 \qquad [ Equation 1 ]$$

$$second sphericity distribution = Sp 90 - Sp 50 \qquad [ Equation 2 ]$$

In Equations 1 and 2, Sp10, Sp50 and Sp90 represent sphericities at volume fractions of 10%, 50%, and 90%, respectively, in a volume-weighted particle size distribution of the natural graphite particles accumulated from the smallest particle size.

For example, the sphericity may represent a circularity and/or an aspect ratio of a particle. For example, the circularity may represent a degree to which the particle is similar to a sphere. For example, the aspect ratio may represent a ratio of a particle length to a particle width.

For example, the sphericity may be calculated by dividing a circumference of a circle with the same area as that of a projection image of a sample by a perimeter of the projection image of the sample using a particle shape analyzer (morphologi 4, Malvern). The equation below can be used to calculate the sphericity:

sphericity=(circumference of a circle having the same area as that of a projection image of a sample)/(perimeter of the projection image of the sample)

The sphericity values obtained as described above of the natural graphite particles may be sorted by the particle size. In the particle size distribution curve based on a volume fraction accumulated from the smallest particle size, the sphericity values at volume fractions of 10%, 50% and 90% are defined as Sp10, Sp50 and Sp90, respectively. A sphericity distribution may be obtained by calculating Sp10, Sp50 and Sp90. For example, as a particle diameter decreases, the sphericity of the particle may decrease. As a particle diameter increases, the sphericity of the particle may increase.

For example, a flake graphite may be spheroidized to form natural graphite particles. During the spheroidization of the flak graphite, particles having larger particle diameters may be easily spheroidized, while particles having smaller particle diameters may not be sufficiently spheroidized.

In some embodiments, as the first sphericity distribution and/or the second sphericity distribution increase, the sphericity of the natural graphite particles may have a non-uniform distribution. In the present disclosure, the non-uniform distribution of sphericity may indicate a widely dispersed sphericity distribution curve with respect to a particle size. For example, as the first sphericity distribution and/or the second sphericity distribution decrease, the sphericity of the natural graphite particles may have a more uniform distribution.

For example, natural graphite may provide improved power and capacity properties. Thus, e.g., when combined with a high-nickel (High-Ni) cathode composition as described below, high-capacity properties may be implemented from each of a cathode and an anode of a secondary battery.

However, natural graphite may have relatively low chemical and mechanical stability or durability compared to that of artificial graphite. For example, repeated charge/discharge cycles may increase expansion of natural graphite to cause damages to a particle or a crystal structure.

In example embodiments, the sphericity distribution of the natural graphite particles may be controlled to improve mechanical stability and durability of the anode active material. Thus, natural graphite may be employed to enhance high-capacity properties and achieve particle durability, thereby improving cycle/life-span properties.

For example, if the first sphericity distribution exceeds 0.25, the number of the natural graphite particles having low sphericity may be excessively increased. Accordingly, the expansion of the natural graphite particles may be increased during repeated charge/discharge cycles. Additionally, particles may not be sufficiently assembled when being spheroidized to cause an excessive increase in the number of flake particles in an active material. Accordingly, the life-span properties may be deteriorated during repeated charge/discharge cycles.

In some embodiments, the first sphericity distribution of the natural graphite particles may be in a range from 0.05 to 0.24, from 0.08 to 0.22, from 0.1 to 0.2, from 0.12 to 0.18, from 0.15 to 0.18, or from 0.15 to 0.16. In the above range, swelling of the natural graphite particles may be reduced, and improved capacity, power and life-span properties may be provided.

For example, if the second sphericity distribution exceeds 0.15, an average sphericity of the natural graphite particles may be decreased to cause an excessive decrease in a tap density of the anode. Further, an electrode adhesion may be decreased to cause deterioration of the life-span properties and capacity properties during repeated charge/discharge cycles.

In some embodiments, the second sphericity distribution of the natural graphite particles may be in a range from 0.01 to 0.14, from 0.02 to 0.12, from 0.03 to 0.10, or from 0.05 to 0.09. In the above range, the tap density may be increased while maintaining a uniform sphericity distribution remains uniform, so that the life-span properties may be improved.

In some embodiments, Sp10 of the natural graphite particles may be in a range from 0.65 to 0.8, or from 0.7 to 0.8.

In some embodiments, Sp50 of the natural graphite particles may be in a range from 0.75 to 0.9, or from 0.8 to 0.9.

In some embodiments, Sp90 of the natural graphite particles may be in a range from 0.85 to 1, or 0.9 or more and less than 1. In the above sphericity range, the sphericity of the natural graphite particles may become uniform to improve durability and an anode density, thereby enhancing the life-span and power properties.

In some embodiments, the average particle diameter (D50) of the natural graphite particles may be in a range from 5 μm to 20 μm, from 7 μm to 18 μm, from 9 μm to 15 μm, or from 10 μm to 12 μm. In the above range, durability of the particles increases and a diffusion path of lithium ions may be reduced to provide improved the power properties.

The particle diameter of the natural graphite particles may be measured using a scanning electron microscope (SEM), a transmission electron microscope (TEM), or a light scattering method. The term “particle diameter” as used herein may refer to the longest diameter of a particle.

For example, the average particle diameter (D50) may represent a particle diameter at a 50% volume fraction in a particle size distribution (PSD) based on a particle volume.

In some embodiments, Dmin of the natural graphite particles may be in a range from 1 μm to 8 μm, or from 3 μm to 7 μm.

In some embodiments, D10 of the natural graphite particles may be in a range from 5 μm to 10 μm, or from 6 μm to 9 μm.

In some embodiments, D90 of the natural graphite particles may be in a range from 12 μm to 25 μm, or from 14 μm to 20 μm.

In some embodiments, Dmax of the natural graphite particles may be in a range from 15 μm to 60 μm, or from 18 μm to 45 μm.

Dmin and Dmax represent minimum and maximum particle sizes, respectively, in the particle size distribution, and D10 and D90 represent particle sizes at volume fractions of 10% and 90%, respectively, in the particle size distribution.

In some embodiments, a tap density of the anode active material may be in a range from 0.9 g/cc to 1.3 g/cc, or from 1.0 g/cc to 1.20 g/cc. In the above range, expansion of the anode may be further suppressed, while further improving the capacity of the anode.

In some embodiments, a specific surface area of the natural graphite particles may be 8 m²/g or less, e.g., in a range from 0.5 m²/g to 5 m²/g, from 1 m²/g to 4 m²/g, from 1 m²/g to 3.5 m²/g, from 1.5 m²/g to 3.5 m²/g, or from 2 m²/g to 3 m²/g. In the above range, side reactions between the natural graphite particles and an electrolyte solution may be reduced, and durability of the particles may be further increased.

In some embodiments, the anode active material may further include a carbon coating layer formed on a surface of the natural graphite particle. Thus, mechanical stability and durability of the anode active material may be increased, and the side reactions with the electrolyte solution may be further suppressed.

In an embodiment, a content of the carbon coating layer based on a total weight of the anode active material may be in a range from 1 wt % to 15 wt %, from 3 wt % to 12 wt %, or from 4 wt % to 10 wt %. In the above range, mechanical strength of the anode active material may be further enhanced while suppressing or preventing deterioration of the capacity and power properties.

In some embodiments, the anode active material may further include a carbon-based active material other than natural graphite, a silicon-based active material, a lithium metal-based active material, or the like, in addition to the natural graphite particles.

According to embodiments of the present disclosure, a method of preparing the anode active material for a secondary battery is provided.

In example embodiments, a flake graphite material having an average particle diameter (D50) of 50 μm to 180 μm is prepared.

For example, if the average particle diameter (D50) of the flake graphite material exceeds 180 μm, the diffusion path of lithium ions within the particles may be excessively increased. Further, non-uniform spheroidization may be performed to cause an excessively irregular spheroidization distribution of the natural graphite material.

For example, if the average particle diameter (D50) of the flake graphite material is less than 50 μm, some flake particles may not be spheroidized to remain in the form of flake particles. Accordingly, particles having excessively low sphericity may be excessively increased, and a contact resistance between the particles may be increased. Thus, durability, mechanical stability and ionic conductivity of the particles may be deteriorated.

In some embodiments, the average particle diameter (D50) of the flake graphite material may be in a range from 60 μm to 170 μm, from 70 μm to 160 μm, from 80 μm to 150 μm, or from 90 μm to 120 μm. In the above range, durability, mechanical stability and ionic conductivity of the particles may be sufficiently achieved.

The flake graphite material may be introduced into a reactor and stirred for 0.5 to 10 hours to spheroidize the flake graphite material. For example, the flake graphite material may be stirred at a high rate to perform a pulverization (e.g., a milling) and spheroidization (e.g., folding). In an embodiment, the folding and milling may be performed by stirring the flake graphite material in the reactor at 500 rpm to 20,000 rpm.

For example, a high-rate mixer, a continuous airflow grinding classifier, or the like, may be used as the reactor, but the reactor is not limited thereto.

For example, a reaction time and/or a reaction rate may be controlled together with the average particle diameter of the flake graphite material to prepare the natural graphite particles having the controlled sphericity distribution as described above.

In some embodiments, after the stirring, an acidic compound may be further added to the reactor to acid-treat the natural graphite particles. Accordingly, purity the purity of the natural graphite particles may be improved.

In some embodiments, the acidic compound may include a strong acid compound, such as hydrofluoric acid (HF), sulfuric acid (H₂SO₄), hydrochloric acid (HCl), or nitric acid (HNO₃).

For example, the acid treatment may be performed at a temperature of 50° C. to 150° C. for 5 to 30 hours. In the above range, the high-purity natural graphite particles may be obtained.

In some embodiments, after the acid treatment, a carbon material may be further added to the reactor and heat-treated to form a carbon coating layer on the surface of the natural graphite particles.

In some embodiments, the carbon material can include an amorphous carbon-based material such as pitch. The heat treatment may be performed at a temperature of 400° C. to 3000° C. for 3 to 48 hours.

According to the method of preparing the anode active material according to the embodiments of the present disclosure, the average particle diameter of the flake graphite material, the reaction time, the stirring rate, etc., may be controlled to provide the anode active material having the above-described sphericity distribution and improved charge/discharge properties.

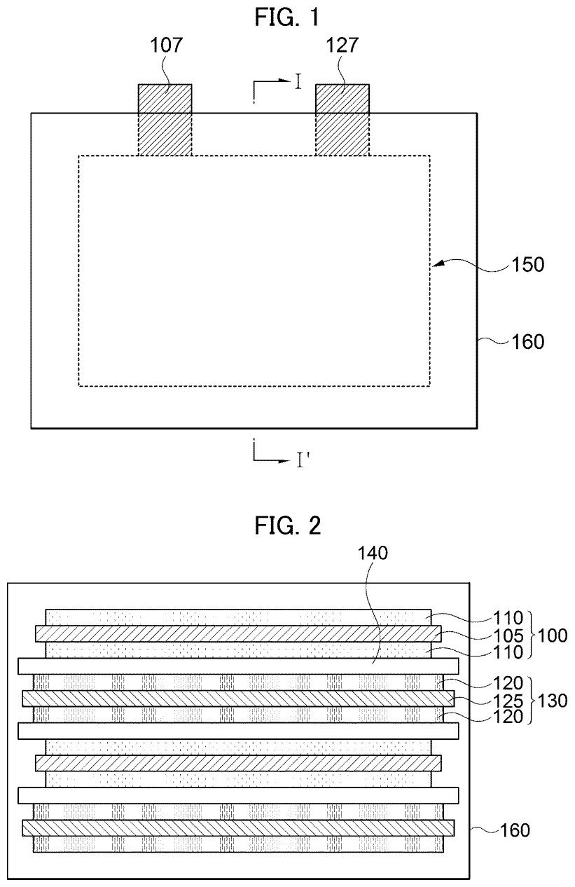

FIGS. 1 and 2 are a schematic plan view and a cross-sectional view respectively, illustrating a secondary battery according to embodiments. For example, FIG. 2 is a cross-sectional view taken along line a I-I′ of FIG. 1.

Referring to FIGS. 1 and 2, the secondary battery includes an anode 130 and a cathode 100 facing the anode 130.

In example embodiments, the anode 130 includes an anode current collector 125, and an anode active material layer 120 formed on the anode current collector 125 and including the above-described anode active material.

In some embodiments, an orientation degree of the anode active material layer 120 defined by Equation 3 below may be 30 or less.

$$orientation degree = I ( 0 \; 04 ) / I ( 110 ) \qquad [ Equation 3 ]$$

In Equation 3, I(004) is a peak intensity of a (004) plane of the anode active material layer 120 measured by an X-ray diffraction (XRD) analysis, and I(110) is a peak intensity of a (110) plane of the anode active material layer 120 measured by the XRD analysis.

For example, I(110) and I(004) may represent peak intensities or maximum peak heights of the (110) plane and the (004) plane, respectively, as determined by the XRD analysis of the anode active material layer 120.

For example, I(004) may be a maximum peak intensity within a diffraction angle (2θ) of 53.5° to 56.0°, and I(110) may be a maximum peak intensity within a diffraction angle (2θ) of 76.5° to 78.5°.

For example, the orientation degree may indicate a degree to which the anode active material particles are aligned in a specific direction. For example, as the orientation degree becomes higher, a degree of isotropy of the anode active material particles may be lowered. As the orientation degree becomes smaller, the degree of isotropy of the anode active material particles may be increased.

In some embodiments, the orientation degree of the anode active material layer 120 may be in a range from 5 to 25, from 10 to 23, or from 15 to 20. In the above range, expansion of the anode active material particles during charge and discharge may be suppressed from being concentrated in a specific direction. Accordingly, swelling of the anode active material layer 120 may be suppressed to further improve operational stability and life-span properties of the secondary battery. Further, in the above range, a conduction path of lithium ions may be reduced to further improve rapid charging properties.

For example, the orientation degree may be obtained by performing the XRD analysis on the anode active material layer 120 that may be formed by coating, drying and pressing an anode slurry containing the above-described anode active material on the anode current collector 125.

The anode slurry may be prepared by mixing and stirring the above-described anode active material with a binder, a conductive material and/or a dispersant in a solvent. The anode slurry may be coated on at least one surface of the anode current collector 125, and then dried and pressed to prepare the anode 130.

The anode current collector 125 may include, e.g., gold, stainless steel, nickel, aluminum, titanium, copper, or an alloy thereof, and may include, e.g., copper or a copper alloy.

The binder may include vinylidene fluoride-hexafluoropropylene copolymer (PVDF-co-HFP), polyvinylidene fluoride (PVDF), polyacrylonitrile, polymethylmethacrylate, or the like.

The conductive material may include a carbon-based conductive material including graphite, carbon black, graphene, carbon nanotube, etc., and/or a metal-based conductive material including tin, tin oxide, titanium oxide, a perovskite material such as LaSrCoO₃ or LaSrMnO₃, etc.

In some embodiments, the binder for forming the anode may include an aqueous binder such as styrene-butadiene rubber (SBR) for compatibility with the carbon-based active material, and may be used together with a thickener such as carboxymethyl cellulose (CMC).

In some embodiments, a content of the above-described natural graphite particles based on a total weight of the anode active material layer 120 may be in a range from 50 wt % to 99 wt %, or from 60 wt % to 99 wt %. In the above range, the secondary battery having improved electrochemical stability and charge-discharge properties may be implemented.

The cathode 100 may include a cathode current collector 105 and a cathode active material layer 110 formed on at least one surface of the cathode current collector 105.

According to embodiments, the cathode active material layer 110 may be formed on both surfaces (e.g., upper and lower surfaces) of the cathode current collector 105. For example, the cathode active material layer 110 may be formed on each of the upper and lower surfaces of the cathode current collector 105.

The cathode current collector 105 may include stainless steel, nickel, aluminum, titanium, or an alloy thereof. The cathode current collector 105 may include aluminum or stainless steel surface-treated with carbon, nickel, titanium or silver.

The cathode active material layer 110 may include a cathode active material, a binder and/or a conductive material. For example, a cathode slurry may be prepared by mixing and stirring the cathode active material with the binder and/or the conductive material in a solvent. The cathode slurry may be coated on the cathode current collector 105, and then dried and pressed to form the cathode active material layer 110.

The cathode active material may include a compound capable of reversibly intercalating and de-intercalating lithium ions.

In example embodiments, the cathode active material may include a lithium-nickel metal oxide. The lithium-nickel metal oxide may further include at least one of cobalt (Co), manganese (Mn) and aluminum (Al).

The cathode active material may include a lithium transition metal oxide represented by Chemical Formula 1.

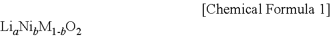

In Chemical Formula 1, 0.95≤a≤1.05, b≥0.5, and M may include at least one element selected from Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba and Sr.

In an embodiment, the lithium transition metal oxide may include nickel (Ni), and may further include at least one of cobalt (Co) and manganese (Mn). For example, the lithium transition metal oxide may include a nickel-cobalt-manganese (NCM)-based lithium oxide.

Nickel (Ni) may be provided as a metal related to the capacity of the lithium secondary battery. As a content of the nickel increases, the capacity and power of the lithium secondary battery may be increased. However, if the content of nickel is excessively increased, mechanical and electrical stability may be degraded.

Cobalt (Co) may be included to improve a conductivity or reduce a resistance of the lithium secondary battery, and manganese (Mn) may be included to improve mechanical and electrical stability of the lithium secondary battery.

The chemical structure represented by Chemical Formula 1 represents a bonding relationship included in a lattice structure or a crystal structure of the cathode active material, and is not intended to exclude introduction of another additional element. For example, M may serve as a main active element of the cathode active material. Chemical Formula 1 is provided to express the bonding relationship of the main active element and is to be understood as a formula encompassing introduction and substitution of the additional element.

In an embodiment, an auxiliary element for enhancing chemical stability of the cathode active material or the crystal structure in addition to the main active element may be further included. The auxiliary element may be incorporated into the crystal structure to form a bond, and this case is to be understood as being included within the range of the chemical structure represented by Chemical Formula 1.

Materials substantially identical to or similar to the aforementioned materials may be used as the binder and conductive material.

In some embodiments, an electrode density of the cathode 100 may be in a range from 3.0 g/cc to 3.9 g/cc, or from 3.2 g/cc to 3.8 g/cc.

In some embodiments, a separator 140 may be interposed between the cathode 100 and the anode 130.

The separator 140 may include a porous polymer film formed of a polyolefin-based polymer such as an ethylene homopolymer, a propylene homopolymer, an ethylene/butene copolymer, an ethylene/hexene copolymer, an ethylene/methacrylate copolymer, etc. The separator 140 may include a nonwoven fabric formed of a glass fiber having a high melting point, a polyethylene terephthalate fiber, or the like.

In example embodiments, an electrode cell may be defined by the cathode 100, the anode 130 and the separator 140, and a plurality of the electrode cells may be repeatedly stacked to form the electrode assembly 150. For example, the electrode assembly 150 may be a winding type, a stacking type, a zigzag-folding type, or a stack-folding type.

The electrode assembly 150 may be accommodated in a case to define a lithium secondary battery.

In an embodiment, an electrolyte solution may be accommodated into the case 160 together with the electrode assembly 150.

In example embodiments, a non-aqueous electrolyte solution may be used as the electrolyte solution.

The non-aqueous electrolyte solution may include a lithium salt as an electrolyte and an organic solvent. The lithium salt may be expressed as, e.g., Li⁺X⁻, and examples of an anion (X−) of the lithium salt may include F⁻, Cl⁻, Br⁻, I⁻, NO₃⁻, N(CN)₂, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻; CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxyethane, diethoxyethane, vinylene carbonate, sulfolane, gamma-butyrolactone, propylene sulfite, tetrahydrofuran, or the like. These may be used alone or in a combination of two or more therefrom.

As illustrated in FIG. 1, electrode tabs (a cathode tab and an anode tab) included in each electrode cell may protrude from the cathode current collector 105 and the anode current collector 125, respectively, to extend to one side of the case 160. The electrode tabs may be fused together with the one side of the case 160 to be connected to an electrode lead (a cathode lead 107 and an anode lead 127) which are extended or exposed to an outside of the case 160.

Although FIG. 1 illustrates that the cathode lead 107 and the anode lead 127 are formed at the same side of the lithium secondary battery or the case 160, the cathode lead 107 and the anode lead 127 may be formed at opposite sides. For example, the cathode lead 107 may be formed at one end portion of the case 160, and the anode lead 127 may be formed at the other end portion of the case 160.

For example, the lithium secondary battery may be manufactured in a cylindrical type using a can, a prismatic type, a pouch type, or a coin type.

Hereinafter, embodiments of the present disclosure are described in more detail with reference to experimental examples. However, the following examples are only given for illustrating the present disclosure and those skilled in the related art will obviously understand that various alterations and modifications are possible within the scope and spirit of the present disclosure. Such alterations and modifications are duly included in the appended claims.

### EXAMPLES AND COMPARATIVE EXAMPLES

### 1. Preparation of Anode Active Material

Flake graphite material was introduced into a reactor, and folding and milling were performed to obtain spherical natural graphite particles.

Specifically, 300 g of the flake graphite material was placed in a continuous grinding classifier and reacted at 5,000 rpm for 2 hours. An average particle diameter (D50) of the flake graphite material was controlled as shown in Table 1.

Fluoric acid, nitric acid and hydrochloric acid were added, and an acid treatment was performed at 80° C. for 12 hours. After washing and drying, the natural graphite particles with a final purity of 99.8% were obtained.

The spherical natural graphite and pitch were mixed in a weight ratio of 95:5, and coating was performed using a blade mill for 30 minutes. Thereafter, the particles were calcined in a roller hearth kiln (RHK) at 1,200° C. in a nitrogen atmosphere for 12 hours. Subsequently, classification and de-ionization processes were performed to form anode active materials (A-1 to A-7).

### 2. Evaluation on Properties of Anode Active Materials

### (1) Measurement of Particle Size

The anode active materials of Examples and Comparative Examples were dispersed in an ethanol dispersion medium (10 wt % aqueous dispersion of sodium hexametaphosphate ((NaPO₃)₆)). An average particle diameter of the natural graphite particles was determined by measuring a difference in diffraction patterns according to particle size using a laser diffraction particle size analyzer (Mastersize 3000, Malvern).

### (2) Measurement of Sphericity

A sphericity distribution of the anode active materials of Examples and Comparative Examples was measured by setting sphericity values at volume fractions of 10%, 50% and 90% as Sp10, Sp50 and Sp90, respectively, when being accumulated from the smallest particle size.

The sphericity was calculated using a particle shape analyzer (Morphologi 4, Malvern) by dividing a circumference of a circle with the same area as that of a projection image of the sample by a perimeter of the projection image as represented by equation below.

$$sphericity = ( circumference of a circle having the same area as that of a projection image of a sample ) / ( perimeter of the projection image of the sample )$$

### (3) Measurement of Specific Surface Area

Specific surface areas of the anode active materials of Examples and Comparative Examples were measured using a surface area measuring device (TriStar 3020) by a BET method based on nitrogen gas adsorption. Specifically, the natural graphite particles were heated to 300° C. under a vacuum condition using a pretreatment device, and then exposed to a nitrogen gas for 120 minutes. After cooling to room temperature, a weight of the sample including the holder was recorded, and a weight of the target sample was input. After adding an appropriate amount of a liquid nitrogen (baseline), the specific surface area was measured.

The measured results are shown together in Table 1.

TABLE 1

| | flake | anode active material | | | | | | |
|---|---|---|---|---|---|---|---|---|
| | graphite | | | | | C − | C − | specific surface |
| | D50(μm) | D50(μm) | Sp10(A) | Sp50(B) | Sp90(C) | A | B | area (m²/g) |
| Example 1(A-1) | 70 | 11 | 0.77 | 0.84 | 0.93 | 0.16 | 0.09 | 2.9 |
| Example 2(A-2) | 100 | 11 | 0.76 | 0.82 | 0.92 | 0.16 | 0.10 | 2.3 |
| Example 3(A-3) | 120 | 11 | 0.75 | 0.83 | 0.91 | 0.16 | 0.08 | 2.5 |
| Example 4(A-4) | 180 | 18 | 0.76 | 0.84 | 0.93 | 0.17 | 0.09 | 2.2 |
| Example 5(A-5) | 110 | 8 | 0.72 | 0.81 | 0.90 | 0.18 | 0.09 | 3.4 |
| Comparative | 45 | 11 | 0.61 | 0.70 | 0.89 | 0.28 | 0.19 | 3.3 |
| Example 1(A-6) | | | | | | | | |
| Comparative | 200 | 13 | 0.58 | 0.71 | 0.88 | 0.30 | 0.17 | 2.8 |
| Example 2(A-7) | | | | | | | | |

Referring to Table 1 above, in Examples where the average particle diameter (D50) of the flake graphite material was adjusted to 50 μm to 180 μm, the flake graphite material was sufficiently spheroidized and assembled to provide a uniform spheroidization distribution.

In Comparative Examples where the average particle diameter (D50) of the flake graphite material was not within the above range, the flake graphite material was not sufficiently spheroidized and assembled to cause an non-uniform spheroidization distribution and excessively increased specific surface area.

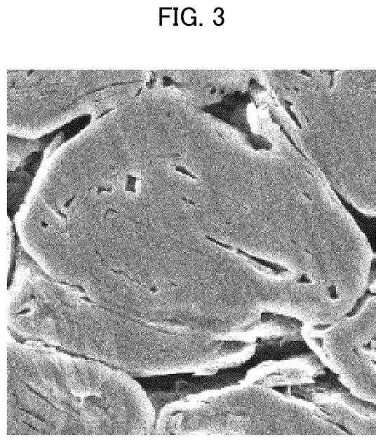

FIGS. 3 to 5 are SEM images of cross-sections of the anode active materials of Examples 1, 2 and Comparative Example 1.

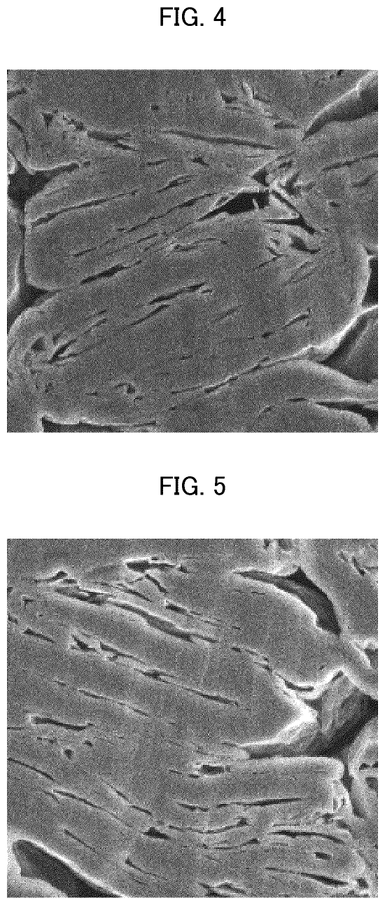

Referring to FIGS. 3 and 4, the anode active materials of Examples 1 and 2 were formed into a more spherical shape by sufficient folding and milling of the flake graphite material.

Referring to FIG. 5, the anode active material of Comparative Example 1 had an excessively reduced average particle size of the flake graphite material, and sufficient spheroidization was not implemented to cause increased irregularities and reduced degree of spheroidization.

### 3. Fabrication of Secondary Battery

### (1) Preparation of Anode for Secondary Battery

An anode slurry was prepared by mixing the above-prepared anode active materials (A-1 to A-7) with carboxymethyl cellulose (CMC) and styrene-butadiene rubber (SBR) as binders in a weight ratio of 97.3:1.2:1.5. The anode slurry was coated, dried and pressed on a copper substrate to obtain an anode.

### (2) Fabrication of Secondary Battery

A slurry was prepared by mixing Li[Ni_{0.6} Co_{0.2}Mn_{0.2}]O₂ as a cathode active material, carbon black as a conductive material, and polyvinylidene fluoride (PVDF) as a binder in a weight ratio of 96.5:2:1.5. The slurry was uniformly coated on an aluminum foil having a thickness of 12 μm, and vacuum-dried at 130° C. to prepare a cathode.

The cathode and the anode prepared in (1) were notched to an appropriate size and stacked with a separator (polyethylene, thickness: 13 μm) interposed therebetween the cathode and anodes.

An electrolyte solution was prepared by adding 1 wt % vinylene carbonate (VC), 0.5 wt % 1,3-propenesultone (PRS), and 0.5 wt % lithium bis(oxalato) borate (LiBOB) to a 1M LiPF₆ solution using a mixed solvent of EC/EMC/DEC (25/45/30; volume ratio).

The cathode/separator/anode assembly was placed in a pouch, and the electrolyte solution was injected into the pouch for impregnation for at least 12 hours to fabricate secondary batteries of Examples and Comparative Examples.

### 4. Evaluation Example

### (1) Measurement of Orientation Degree of Anode Active Material Layer

An XRD analysis was performed on the anode active material layers included in the anodes of Examples and Comparative Examples. A peak intensity corresponding to a (004) plane (I(004)) and a peak intensity corresponding to a (110) plane (I(110)) were measured, to determine an orientation degree of the anode active material layer.

Specifically, a maximum peak intensity within a diffraction angle (20) range of 53.5° to 56.0° was selected as the I(004) value, and a maximum peak intensity within a diffraction angle (2θ) range of 76.5° to 78.5° was selected as the I(110) value.

The measured I(004) and I(110) values were substituted into Equation 3 to determine the orientation degree of the anode active material layer.

Specific XRD analysis equipment and conditions are shown in Table 2 below.

TABLE 2
<XRD analysis equipment and conditions>

| Maker | PANalytical | |
|---|---|---|
| Anode material | Cu | |
| K-Alpha1 wavelength | 1.540598 | Å |
| Generator voltage | 45 | kV |
| Tube current | 40 | mA |

| Scan Range | 10~120° |
|---|---|
| Scan Step Size | 0.0065° |
| Divergence slit | ¼° |
| Antiscatter slit | ½° |

### (2) Evaluation on Rapid Charge Property (25° C.)

The secondary batteries of Examples and Comparative Examples were charged (CC/CV, 0.3 C, 4.2V, cutoff 0.05 C) and discharged (CC, 0.3 C, 2.5V cutoff) at 25° C., and an initial discharge capacity A was measured. Subsequently, a rapid charging to 80% SOC at step-wise current values ranging from 1.25 C to 3.0 C at 25° C. and discharging to 8% SOC at 0.3 C as one cycle were repeated by 150 cycles.

After the 150 cycles, charging (CC/CV, 0.3 C, 4.2V, cutoff 0.05 C) and discharging (CC, 0.3 C, 2.5V cutoff) were performed to measure a discharge capacity B. A rapid charge property was evaluated as a percentage of the discharge capacity B divided by the initial discharge capacity A.

### (3) Evaluation on Life-Span Property (25° C.)

The secondary batteries of Examples and Comparative Examples were subjected to 500 charge-discharge cycles in a 25° C. chamber to evaluate room-temperature life-span properties. Specifically, 500 cycles with each cycle including a charge (CC-CV 0.5 C 4.2V 0.05 C CUT-OFF) and a discharge (CC 0.5 C 2.5V CUT-OFF) were performed. The room-temperature life-span property was evaluated as a percentage of a discharge capacity at the 500th cycle relative compared to a discharge capacity at the 1st cycle.

The secondary batteries of Examples and Comparative Examples were subjected to 500 cycles of charge/discharge at 25° C., with each cycle including a charge (CC/CV, 0.5 C, 4.2V, cutoff 0.05 C) and a discharge (CC, 0.5 C, 2.5V cutoff). A capacity retention was evaluated as a percentage of a discharge capacity after 500th cycles divided by the discharge capacity after the 1st cycle.

The results of (1) to (3) are shown in Table 3 below.

TABLE 3

| | | rapid charge | life-span |
|---|---|---|---|
| | | property | property |
| | orientation | capacity | capacity |
| | degree | retention (%) | retention (%) |
| Example 1 | 18.8 | 100 | 95 |
| Example 2 | 17.2 | 95 | 100 |
| Example 3 | 20.1 | 96 | 97 |
| Example 4 | 23.7 | 80 | 99 |
| Example 5 | 15.3 | 97 | 90 |
| Comparative | 29.6 | 75 | 60 |
| Example 1 | | | |
| Comparative | 41.5 | 55 | 80 |
| Example 2 | | | |

Referring to Table 3, in Examples where the first sphericity distribution was adjusted to 0.25 or less, and the second sphericity distribution was adjusted to 0.15 or less provided improved rapid charge and life-span properties.

The above descriptions are merely examples applying the inventive concepts of the present disclosure, and other elements may be further included without departing from the scope of the present disclosure.

What is claimed is:

1. An anode active material for a secondary battery comprising natural graphite particles, wherein a first sphericity distribution defined by Equation 1 of the natural graphite particles is 0.25 or less, and a second sphericity distribution defined by Equation 2 of the natural graphite particles is 0.15 or less:
$$first sphericity distribution = Sp 90 - Sp 10 \qquad [ Equation 1 ]$$
$$second sphericity distribution = Sp 90 - Sp 50 \qquad [ Equation 2 ]$$
wherein, in Equations 1 and 2, Sp10, Sp50 and Sp90 represent sphericities at volume fractions of 10%, 50% and 90%, respectively, in a volume-weighted particle size distribution of the natural graphite particles accumulated from the smallest particle size.

2. The anode active material for a secondary battery of claim 1, wherein the first sphericity distribution of the natural graphite particles is in a range from 0.1 to 0.2.

3. The anode active material for a secondary battery of claim 1, wherein the second sphericity distribution of the natural graphite particles is in a range from 0.03 to 0.10.

4. The anode active material for a secondary battery of claim 1, wherein Sp10 of the natural graphite particles is in a range from 0.65 to 0.8.

5. The anode active material for a secondary battery of claim 1, wherein Sp50 of the natural graphite particles is in a range from 0.75 to 0.9.

6. The anode active material for a secondary battery of claim 1, wherein Sp90 of the natural graphite particles is in a range from 0.85 to 1.

7. The anode active material for a secondary battery of claim 1, wherein an average particle diameter (D50) of the natural graphite particles is in a range from 5 μm to 20 μm.

8. The anode active material for a secondary battery of claim 1, wherein a specific surface area of the natural graphite particles is 8 m²/g or less.

9. The anode active material for a secondary battery of claim 1, further comprising a carbon coating layer formed on a surface of the natural graphite particles,
wherein a content of the carbon coating layer is in a range from 1 wt % to 15 wt % based on a total weight of the anode active material.

10. An anode for a secondary battery, comprising:
an anode current collector; and
an anode active material layer formed on the anode current collector and comprising the anode active material for a secondary battery of claim 1.

11. The anode for a secondary battery of claim 10, wherein an orientation degree of the anode active material layer defined by Equation 3 is 30 or less:
$$orientation degree = I ( 0 \; 04 ) / I ( 110 ) \qquad [ Equation 3 ]$$
wherein, in Equation 3, I(004) is a peak intensity of a (004) plane of the anode active material layer measured by an X-ray diffraction (XRD) analysis, and I(110) is a peak intensity of a (110) plane of the anode active material layer measured by the XRD analysis.

12. A secondary battery, comprising:
the anode for a secondary battery of claim 10; and
a cathode opposing the anode.

13. A method for preparing an anode active material for a secondary battery, comprising:
introducing a flake graphite material having an average particle diameter (D50) of 50 μm to 180 μm into a reactor; and
stirring the flake graphite material for 0.5 to 10 hours to prepare natural graphite particles,
wherein a first sphericity distribution defined by Equation 1 of the natural graphite particles is 0.25 or less, and a second sphericity distribution defined by Equation 2 of the natural graphite particles is 0.15 or less:
$$first sphericity distribution = Sp 90 - Sp 10 \qquad [ Equation 1 ]$$
$$second sphericity distribution = Sp 90 - Sp 50 \qquad [ Equation 2 ]$$
wherein, in Equations 1 and 2, Sp10, Sp50 and Sp90 represent sphericities at volume fractions of 10%, 50% and 90%, respectively, in a volume-weighted particle size distribution of the natural graphite particles accumulated from the smallest particle size.

14. The method of claim 13, wherein an average particle diameter (D50) of the flake graphite material is 80 μm to 150 μm.

15. The method of claim 13, wherein, a stirring rate of the flake graphite material in the stirring is in a range from 500 rpm to 20,000 rpm.

16. The method of claim 13, further comprising adding an acidic compound to the reactor to acid-treat the natural graphite particles after the stirring.

17. The method of claim 16, further comprising after the acid-treatment:
adding a carbon material to the reactor; and
performing a heat treatment to form a carbon coating layer on the surface of the natural graphite particles.
